(19) United States
(12) Patent Application Publication
(10) Pub. No.: US 2021/0079796 A1
(43) Pub. Date: Mar. 18, 2021

(54) METHOD FOR SELECTIVELY IRRADIATING A MATERIAL LAYER, PRODUCTION METHOD, AND COMPUTER PROGRAM PRODUCT

(71) Applicant: Siemens Aktiengesellschaft, Munich (DE)

(72) Inventor: Ole Geisen, Berlin (DE)

(73) Assignee: Siemens Aktiengesellschaft, Munich (DE)

(21) Appl. No.: 16/959,701

(22) PCT Filed: Jan. 8, 2019
(86) PCT No.: PCT/EP2019/050309

§ 371 Date: Jul. 2, 2020

(30) Foreign Application Priority Data
Feb. 6, 2018 (EP) 18155290.2

(51) Int. Cl. F01D 5/28; B22F 3/105; B22F 5/04; B33Y 50/02

(52) U.S. Cl. CPC F01D 5/28; B22F 3/1055; B33Y 10/00; B33Y 50/02; B22F 5/04

(57) ABSTRACT

A method for selectively irradiating a material layer in additive manufacturing, the method includes: providing a predetermined component geometry which contains geometrical information of individual layers of a component to be manufactured additively; and defining layer by layer an irradiation pattern in areas of a layer to be constructed for the manufacturing of the component, the irradiation pattern comprising irradiation vectors in each area; and, if a predefined irradiation vector length is not reached in a first area, lengthening irradiation vectors in a second area of the layer adjacent to the first area as far as a component contour.

### CROSS REFERENCE TO RELATED APPLICATIONS

This application is the U.S. National Stage of International Application No. PCT/EP2019/050309 filed 8 Jan. 2019, and claims the benefit thereof. The International Application claims the benefit of European Application No. EP18155290 filed 6 Feb. 2018. All of the applications are incorporated by reference herein in their entirety.

### FIELD OF INVENTION

The present invention relates to a method for selectively irradiating a material layer in additive production, to a corresponding additive production method, to a component produced with this production method, and to a corresponding computer program product.

The selective irradiation method may constitute or comprise a CAM (computer-aided manufacturing) method.

The component advantageously denotes a component intended for use in a turbomachine, advantageously in the hot-gas path of a gas turbine. Correspondingly, the component advantageously consists of or comprises a nickel-based or cobalt-based superalloy. The alloy may furthermore be precipitation-hardened or dispersion-hardened.

### BACKGROUND OF INVENTION

Generative or additive production methods suitable for the components described comprise, for example, as powder bed methods selective laser melting (SLM) or laser sintering (SLS), or electron beam melting (EBM).

A selective laser melting method is known, for example, from EP 2 601 006 B1.

Additive manufacturing methods have proven particularly advantageous for complex or complicatedly or filigree-designed components, for example labyrinth-like structures, cooling structures and/or lightweight structures.

In particular, additive manufacture is advantageous because of a particularly short chain of processing steps, since a step of production or manufacture of the component can be carried out on the basis of a corresponding CAD file.

Conventionally, a component geometry is defined or provided, for example by means of such a CAD file, and this geometry is subdivided into individual layers (slicing) in the scope of computer-aided manufacturing methods. For the selective solidification of these layers, which for the final (physical) production of the component may for example consist of a base material in powder form, an irradiation pattern having individual irradiation vectors is then established for each component layer to be solidified. This is advantageously likewise carried out with computer aid, for example by means of a CAM method.

The layer thicknesses, into which the design model of the component is subdivided in this way, may in the subsequent production be less than 100 μm, for example from 40 μm to 60 μm, depending on the desired geometrical resolution. The number of layers and also the number of irradiation patterns or irradiation trajectories to be established are correspondingly high. Expediently, an irradiation pattern is established only in the lateral regions or surface regions actually to be solidified of a layer to be solidified. The surface regions may denote virtual or modeled regions in the layer plane of a component layer or also—insofar as the physical construction of the component is taken into account—a region as seen in a plan view of the powder bed.

The irradiation may, for example, be carried out by means of an electron beam or a laser beam selectively according to the desired geometry of the component, the powder initially being melted in the surface regions to be solidified and set or solidified in order to produce the structure of the component.

For the CAM method preparing the actual physical additive production of the component the irradiation paths (irradiation patterns) are advantageously arranged in such a way that the powder layer can be scanned and melted, for example surface-wide. To this end, the layer to be solidified is advantageously subdivided into the aforementioned surface elements or surface regions, for example strips or checkerboard-like surfaces or surface segments.

The irradiation pattern is advantageously established in such a way that an energy beam (electron beam or laser) can subsequently be guided or scanned in a meandering shape over the layers. For such irradiation, meandering irradiation vectors, which for example form the irradiation pattern, are thus established.

After a layer has been irradiated with the energy beam in the course of the powder bed-based process, the irradiation pattern is generally rotated relative to the construction plate in order to prevent structural defects in the component, which may occur for example because of laser paths arranged directly above one another, and in order to generate a more homogeneous configuration in the component. At the same time, it means that the irradiation pattern is or has to be adapted layerwise, and the lengths of the irradiation vectors may vary greatly from layer to layer. One problem which occurs more greatly because of this situation is local overheating, which is caused by irradiation vectors (scan vectors) that are too short. This overheating advantageously occurs at layer edges or sides, or at other regions of the layer in which the contour of the layer is highly curved.

The reason why the overheating occurs precisely during production because of irradiation vectors that are too short in length is that in a particular surface region, the energy beam passes several times over the same or adjacent surface regions in a short time, and the heat is possibly never dissipated sufficiently from this region. In other words, the radiation power or energy density (per unit time) which is introduced by the energy beam into the powder bed during the irradiation may be too great in the case of an irradiation pattern having irradiation vectors that are too short.

Particularly for the construction of component parts from high-performance materials, such as superalloys, which are susceptible to hot cracks, the aforementioned overheating may lead to irreparable structural defects. Furthermore, these excessively high temperature exposures during the process may lead to deformations (lifting) and stresses of edge regions of the component, which may also lead to a coating tool, which ensures the layer application of the powder or base material, colliding with this edge region during production.

### SUMMARY OF INVENTION

It is therefore an object of the present invention to provide means which avoid the aforementioned overheating in the process and can therefore lead to an improved component quality, a better dimensional accuracy, a more homogeneous configuration of the component and furthermore an increased process reliability.

This object is achieved by the subject-matter of the independent patent claims. The dependent claims relate to advantageous configurations.

One aspect of the present invention relates to a method for selectively irradiating a material layer in the additive production or manufacturing of a component. The material layer may consist of a base material which is in powder form or liquid.

The method comprises providing or reading in a predetermined component geometry, for example a design file (CAD) or a 3D scan of the component. The component geometry contains geometrical information of individual layers of the component to be additively produced.

The method furthermore comprises layerwise establishing of an irradiation pattern in surface regions (for example strips or checkerboard-like regions) of a layer to be constructed for the component, the irradiation pattern comprising irradiation vectors in each surface region, and—when a (pre)defined irradiation vector length is fallen below in a first surface region, for example by a given or current irradiation vector–lengthening irradiation vectors in a second surface region, adjacent to the first surface region, of the layer as far as a component contour.

The irradiation vectors in the aforementioned second surface region are advantageously lengthened “at the cost” of the length of the irradiation vectors into the first surface region.

Preferably, the reason why the length of the aforementioned irradiation vector in the first surface region is less than the predefined irradiation vector length is that this first surface region denotes an edge or a side of the component layer. The component contour may, for example, correspondingly denote an edge of the geometry of the component or an edge of the layer.

The predefined irradiation vector length may be a minimum irradiation vector length, i.e. one below which excess destructive overheating of the layer is to be expected during the process.

In other words, the irradiation vectors of the adjacent second surface region are advantageously lengthened into the original first surface region when, for example, a vector currently to be established (actual vector) falls below the value of the predefined irradiation vector length.

The lengthening of the irradiation vectors is carried out in the scope of the present invention with computer aid on a data basis so that ultimately the irradiation vectors are no longer too short in length, and no longer lead to overheating, during the production of the component.

The method may describe an adaptive computer-aided measure in the scope of CAM, which establishes the irradiation vectors in such a way that the irradiation vectors, for example empirical or with the aid of estimated, calculated and/or simulated results, have a minimum length which, when applied in the actual production process, avoids the problems described.

By the solution described, the substantial difficulties which additive manufacturing currently has in respect of its industrialization and reproducibility, may be solved. The measures specified by the present invention therefore mean a crucial improvement which, in particular directly during the preparation of a construction process, leads to significantly improved material and structural properties of the component.

In one configuration, the irradiation vectors in the second surface region are lengthened surface-wide as far as the component contour in order to prevent simulated, estimated and/or calculated local overheating by irradiation vectors that are too short in the first surface region. The aforementioned estimation or calculation may, for example, be carried out with the aid of a simulation which takes into account the input of heat into the powder bed, or into the component, and/or structural properties of the component.

In one configuration, the layerwise establishment is carried out with computer aid by means of a CAM method.

In one configuration, the irradiation pattern is established and stored for all layers of the component to be additively produced. This configuration advantageously makes it possible subsequently to draw conclusions about the selected or established irradiation strategy (irradiation pattern) in the event that structural defects occur in the component. This configuration may furthermore be helpful for generating or developing a “digital twin” of the component.

In one configuration, the information of the irradiation pattern for the component is provided and/or linked layerwise with the geometrical information of individual layers of the component in a common data set. The common data set may for example be an xml format, an amf file (.amf), a comparable format or another CAM data set, which in addition to the geometrical information (design information) contains, for example, information about the selected irradiation parameters, such as the scan or irradiation speed, laser power, track, strip or “hatch” distance and/or strip width. By means of these parameters, for example, the radiation power or radiation energy per time interval introduced into the powder material and/or the solidified layer may be adjusted, calculated and stored in the scope of the embodiment described.

A further aspect of the present invention relates to an additive production method comprising the described selective irradiation method, wherein the selective irradiation is carried out by means of a laser or an electron beam.

In one configuration, the material layer is a powder layer.

In one configuration, the material of the powder layer is made of an in particular hardened nickel-based or cobalt-based superalloy.

In one configuration, the component is a component part to be used in the hot-gas path of a turbomachine.

A further aspect of the present invention relates to a component which is produced or producible by the described additive production method, furthermore comprising—in comparison with a component produced according to the prior art—a dimensional accuracy improved for example by 50 to 100%. The dimensional accuracy or dimensional accuracy tolerance may, for example, denote a difference or distance between an allowed maximum dimension and an allowed minimum dimension (measured along an arbitrary extent) of the component; a tolerance improved in relation to a given dimension accuracy in this sense may denote, for example, a reduction of the tolerance distance. An improvement of the dimensional accuracy or dimensional accuracy tolerance by 100% is in the present case intended, for example, to denote halving of the tolerance distance.

In addition, the component advantageously has a more homogeneous structure, and/or an improved material structure in respect of structural faults, such as hot cracks, in relation to a known component, and correspondingly improved material properties.

A further aspect of the present invention relates to a computer program or a computer program product comprising instructions which, when the program is executed by a computer or a data processing device, cause the latter to carry out the layerwise establishment of the irradiation pattern.

Configurations, features and/or advantages which relate here to the selective irradiation method and/or the computer program product, may furthermore relate to the additive production method and/or to the component, and vice versa.

### BRIEF DESCRIPTION OF THE DRAWINGS

Further details of the invention will be described below with the aid of the figures.

FIG. 1 shows a schematic view of a material layer of a component to be additively constructed, as well as a subdivision of the material layer into strip-like surface regions.

FIG. 2 shows a detail view of FIG. 1 and an exemplary irradiation pattern.

FIG. 3 shows a representation similar to FIG. 1 or FIG. 2 with further information indicated.

FIG. 4 indicates, with the aid of a representation similar to the preceding figures, a solution according to the invention to the problem described here.

FIG. 5 indicates method steps according to the invention with the aid of a schematic flowchart.

FIG. 6 indicates an additive production process of a component with the aid of a schematic side view.

### DETAILED DESCRIPTION OF INVENTION

In the exemplary embodiments and figures, elements which are the same or have the same effect may respectively be provided with the same references. The elements represented and their size proportions with respect to one another are not in principle to be regarded as true to scale; rather, individual elements may be represented exaggeratedly thick or largely dimensioned for better representability and/or for better comprehensibility.

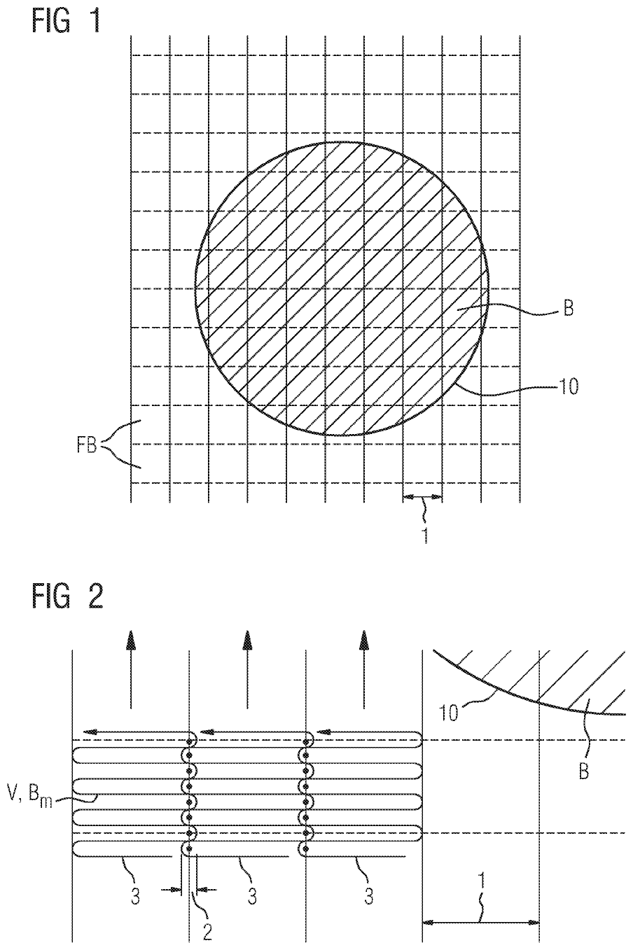

FIG. 1 shows a component, or a part thereof, in a plan view. The component, or a design model (CAD file) of the component, is denoted by the reference B. The part of the component B represented as being round may furthermore denote a cross-sectional view of the component—for example during its additive production, or of a modeled layer thereof.

The component is advantageously a component which is used in the hot-gas path of a turbomachine, for example of a gas turbine. In particular, the component may be a rotor blade or guide vane, a segment or ring segment, a burner part or a burner tip, a frame, a shield, a nozzle, seal, a filter, an opening or a lance, a resonator, a prop or a turbulator, or a corresponding junction, insert or a corresponding retrofit part.

Although the component B is usually represented as being at least round or cylindrical in the described drawings, it may have any desired predefined geometry, in particular even a particularly complicated or filigree geometry.

In order to produce corresponding components, among additive methods, selective laser melting or electron beam melting are often used, an energy beam being guided selectively on the basis of an established irradiation pattern over a powder bed so as to produce the desired structure of the component B according to the predetermined geometry.

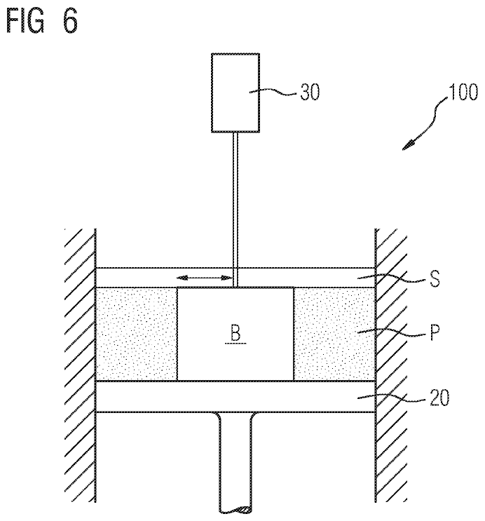

In FIG. 6, in this regard it is described here that after the preparatory CAM process steps, the component B is finally constructed by selective irradiation from a powder bed P on a construction platform 20. The irradiation is carried out by means of a laser or electron beam emitted by an irradiation device 30, advantageously layerwise (cf. layer S in FIG. 6).

The component B has a component contour 10. The component contour 10 denotes merely an edge of the component. Unlike as represented in the figures, however, this edge or this contour may be an inner-lying contour, for example also the contour of a cavity.

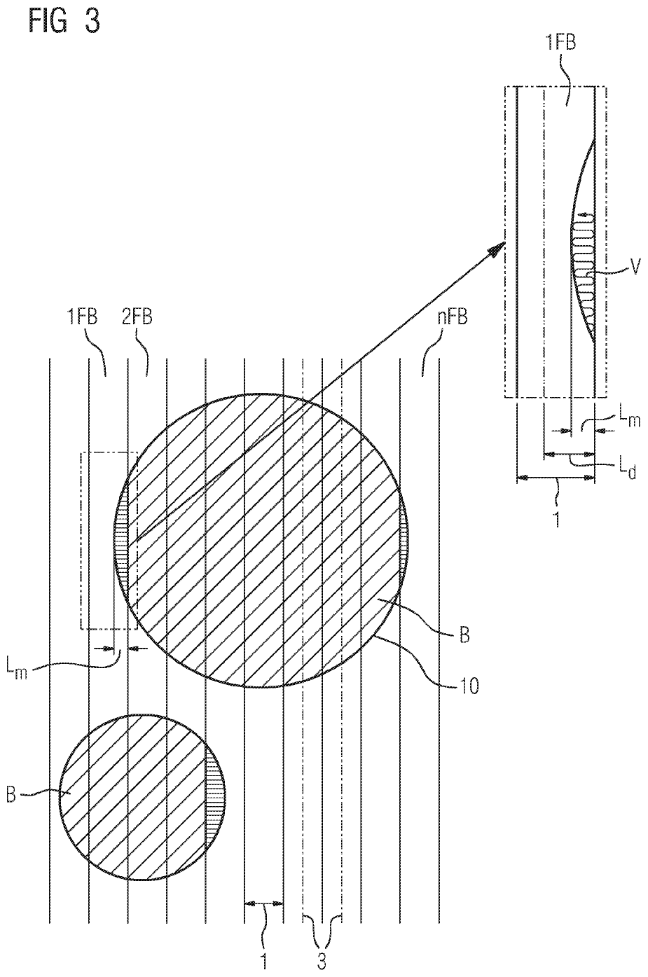

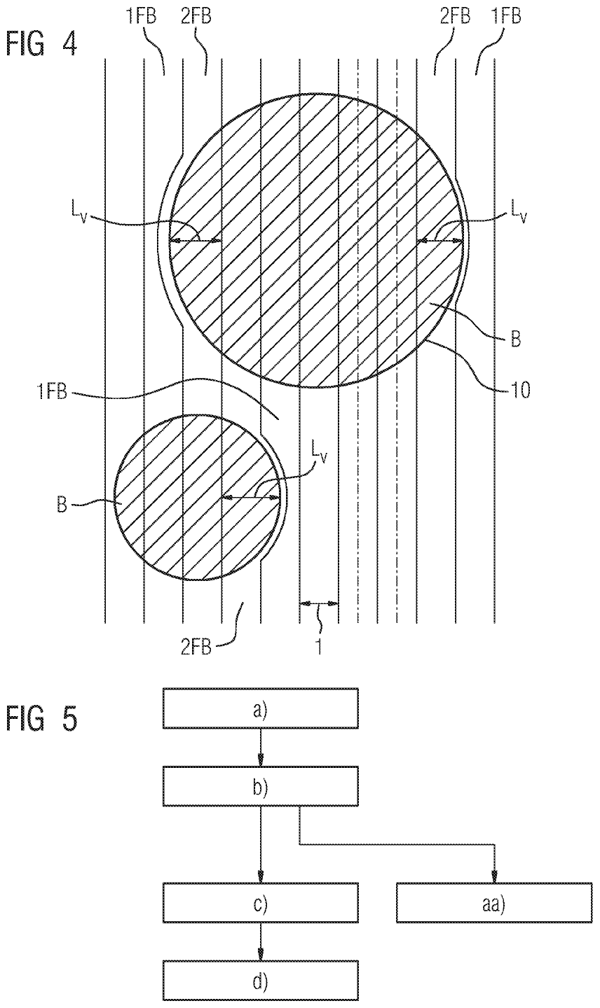

In the representation of FIG. 1, the layer of the component B is overlaid with a strip pattern (vertical straight separating lines of the strips are not explicitly marked), which has a strip width 1. Each strip of the strip pattern advantageously denotes a surface region (compare FIGS. 3 and 4) in which an irradiation pattern can be established for the additive production of the component (compare FIG. 2). A strip width is in the present case denoted by the reference 1.

In addition or as an alternative to the strip pattern, a checkerboard subdivision of surface regions may be provided (likewise compare solid and dashed lines in FIGS. 1 and 2).

The aforementioned subdivision into surface sections or surface regions is advantageously carried out with computer aid on a data basis by means of the CAM method.

During the strip-like irradiation or illumination, an entire strip is advantageously irradiated first, for example from top to bottom, according to the previously established irradiation pattern before changing to the next strip. In the case of a checkerboard-like irradiation process, on the other hand, individual checkerboard surfaces may for example be randomly established successively for the irradiation.

FIG. 2 shows an enlarged view of the lower left region of FIG. 1. The component B and the component contour 10 are shown at the top right in FIG. 2.

By way of example - for the sake of better clarity outside the component B—strips having a strip distance 1 are indicated, which in the present case represent the surface regions FB in which the irradiation pattern BM is defined or established (cf. FIGS. 3 and 4). The dashed lines indicate that the surface to be irradiated may also be irradiated, or scanned, with an energy beam (compare FIG. 6) in a checkerboard manner instead of a strip manner.

The straight arrows shown in FIG. 2 indicate a superordinate irradiation direction, according to which the energy beam may be guided over the powder bed as furthermore specified by the geometry of the component B.

A powder bed is not represented in FIGS. 1 to 4 for the sake of simplicity. Preferably, however, the region of the component B may denote that region of the powder bed which is irradiated for the additive production of the component.

For each strip-like surface region (compare FIG. 3), an irradiation pattern BM is advantageously composed of meandering irradiation vectors V. In other words, the “meander geometry” may be modulated onto the superordinate irradiation direction (cf. straight arrows in FIG. 2).

It may furthermore be seen in FIG. 2 that irradiation vectors V of adjacent strips or surface regions overlap at the edge of the strips in a strip overlap or overlap region 2, so that the powder bed is actually irradiated surface-wide and can therefore be solidified according to the geometry of the component, and for instance structure regions do not remain in the powder or porous state. The positions marked by the reference 3 in this case denote the midpoint paths of the energy beam (not explicitly marked here).

Because of the overlap of the strips, during the irradiation of a second strip (cf. central straight arrow), those regions which overlap with an adjacent, previously irradiated first strip (cf. left straight arrow) are melted again by the energy beam. This may likewise have a positive effect on the resulting material structure.

In a similar way to FIGS. 1 and 2, FIG. 3 shows two component regions or component layers B, which in the plan view represented are not connected on the layer to be solidified. The two geometries are represented merely by way of example with round contours 10.

FIGS. 1 to 3 may in the present case in particular describe a situation of the prior art, in which the solutions according to the invention are not yet implemented. In particular, it may be seen in the upper region of FIG. 3 that the component layer B protrudes only slightly beyond the strip boundaries at the left and right edges. These regions are denoted in the present case by the reference 1FB as first surface regions. In these regions, the irradiation vectors V are now likewise compiled and established by a computer-aided method (CAM method) preparing for the additive production process (compare the enlarged section of the first surface region at the top right in FIG. 3).

These first surface regions 1FB are in the present case arranged adjacent to second surface regions 2FB of the component B.

Irradiation vectors V in the present case in particular mean each section of the irradiation pattern BM which directly extends perpendicularly to the strips, i.e. along the direct strip distance 1.

Each individual irradiation vector V in any case, and also of the first surface region 1FB, is expediently established only inside the component contour 10. Each irradiation vector V of the first surface region 1FB furthermore comprises only vectors V having an irradiation vector length of at most Lₘ, which is less than the strip distance 1. Likewise compare with this the enlarged section at the top right in FIG. 3, in which a meandering irradiation pattern having vectors V may be seen.

Consequently, as described above, input of heat into these regions during the irradiation is greater since a laser or electron beam scans this locally limited section more often in a given time, and the melt bath or a thermally affected zone of the energy beam is constantly arranged in the second surface region/s 2FB. This leads to the disadvantages described above, such as deficient material structure, and to possible collisions of the component B with a coater (not explicitly denoted here).

In the enlarged section the top right in FIG. 3, a predefined and/or minimum irradiation vector length L_{d} is furthermore denoted, which may for example be estimated, simulated and/or calculated in the course of the described CAM method, and advantageously corresponds to that irradiation vector length according to which the component B must be at least scanned or irradiated so that the inputs of energy into the structure of the component B do not become too great. The irradiation vector length L_{d} may, for example, be between 50 and 200 μm.

FIG. 4 now shows the way in which the method according to the invention as described here avoids the local overheating in the second surface regions by a corresponding treatment of the irradiation vectors V of the irradiation pattern BM. In FIG. 4 the first surface regions 1FB, correspondingly hatched differently according to FIG. 3, of the component B are no longer denoted in overlap with the component contour B, 10. Instead, FIG. 4 indicates by the round profile of the strip boundaries or strip separating lines that the second surface regions 2FB have been increased at the cost of the first surface regions 1FB, in that the irradiation vectors V of the irradiation pattern BM have been increased to a length Lᵥ (cf. double arrow). This prevents the above-described disadvantages and solves the problem of the present invention. Since the irradiation vectors V of the second surface regions in FIG. 2 are now in fact greater than the strip distance 1, the problem of overheating during the (layerwise) additive production of the component no longer occurs.

The component which has been additively constructed on the basis of the irradiation pattern BM established as described above in FIG. 4, for example by a selective laser melting method (compare FIG. 6), now comprises, for example, a material structure improved in comparison with a component produced according to the prior art, in particular an improved hardness, strength or hot crack susceptibility, and/or a more homogeneous or more favorable phase configuration, for example in respect of the γ or γ′ precipitates in superalloys.

Preferably, the component produced in this way is furthermore distinguished by an (in contrast to the prior art) improved dimensional accuracy or dimensional accuracy tolerance, advantageously a dimensional accuracy improved by 50 to 100%.

FIG. 5 represents the method according to the invention with the aid of a schematic flowchart. The aforementioned method is advantageously a method for selectively irradiating a material layer in additive production.

It comprises, in method step a), the provision of a predetermined component geometry B which contains geometrical information of the individual layers S (cf. FIG. 6) of a component B to be additively produced. This may, for example, be carried out by reading a CAD file, for example into a corresponding additive production system or a corresponding data processing device or a computer.

The method furthermore comprises, in method step b), the layerwise establishment of the irradiation pattern BM (as described above) in surface regions of a layer S to be constructed for the production of the component B, the irradiation pattern BM comprising irradiation vectors V in each surface region.

Method step aa) indicates that irradiation vectors of length Lₘ in the second surface region or regions 2FB of the layer S are lengthened as far as the component contour 10 (cf. FIG. 4) when the (pre)defined irradiation vector length L_{d} of a given vector in the first surface region 1FB is fallen below.

The method furthermore comprises, in method step c), the establishment and storage of the irradiation pattern BM for all layers S of the component B, or all layers of the component B which are susceptible to structural faults or overheating, for example because of their desired and defined geometry.

The method furthermore comprises, in method step d), the layerwise linking and/or provision of the information of the irradiation pattern BM for the component B together with the geometrical information (CAD) of individual layers of the component in a common data set, for example in an STL, AMF or G-Code format.

The description with the aid of the exemplary embodiments does not restrict the invention to these exemplary embodiments; rather, the invention comprises any new feature and any combination of features. This includes in particular any combination of features in the patent claims, even if this feature or this combination per se is not specifically indicated in the patent claims or exemplary embodiments.

1. A method for selectively irradiating a material layer in additive production, the method comprising:
a) providing a predetermined component geometry which contains geometrical information of individual layers of a component to be additively produced,
b) layerwise establishing an irradiation pattern in surface regions of a layer to be constructed for the production of the component, the irradiation pattern comprising irradiation vectors in each surface region, the layerwise establishment being carried out with computer aid by means of a CAM method, and
aa) when a predefined irradiation vector length is fallen below in a first surface region, lengthening irradiation vectors in a second surface region, adjacent to the first surface region, of the layer as far as a component contour.

2. The method as claimed in claim 1,
wherein the irradiation vectors in the second surface region are lengthened as far as the component contour in order to prevent estimated or calculated local overheating by irradiation vectors that are too short in the first surface region.

3. The method as claimed in claim 1, further comprising:
c) storing the irradiation pattern that is established for all layers of the component to be additively produced.

4. The method as claimed in claim 3, further comprising:
d) providing the information of the irradiation pattern for the component layerwise with the geometrical information of individual layers of the component in a common data set.

5. An additive production method, comprising:
implementing the method for selectively irradiating a material layer as claimed in claim 1,
wherein the selective irradiation is carried out by means of a laser or an electron beam, and the material layer is a powder layer.

6. The additive production method as claimed in claim 5,
wherein the powder layer is a hardened nickel-based or cobalt-based superalloy, and the component is a component part to be used in a hot-gas path of a turbomachine.

7. A component which is produced or producible by the method as claimed in claim 5, furthermore comprising:
in comparison with a component produced according to the prior art, a dimensional accuracy improved by 50 to 100%.

8. A computer program product stored on a non-transitory computer readable media, comprising:
instructions which, when the computer program is executed by a computer, cause the computer to carry out step b) of the layerwise establishment of the irradiation pattern as claimed in claim 1.
